(19) United States
(12) Patent Application Publication
(10) Pub. No.: US 2020/0062668 A1
(43) Pub. Date: Feb. 27, 2020

(54) SYSTEM AND METHOD FOR THERMALLY TREATING MATERIAL DURING PELLETING

(71) Applicant: NUORGANICS LLC, Robbinsville, NJ (US)

(72) Inventors: Eugenio Giraldo, Robbinsville, NJ (US); Barbara Jean Wingler, Robbinsville, NJ (US)

(21) Appl. No.: 16/547,973

(22) Filed: Aug. 22, 2019

Related U.S. Application Data
(60) Provisional application No. 62/720,998, filed on Aug. 22, 2018.

(51) Int. Cl. C05G 3/00; C05F 11/08; C05F 3/00; C05F 5/00; C05F 1/00

(52) U.S. Cl. CPC C05G 3/0058; C05F 11/08; B01J 2/20; C05F 5/002; C05F 1/005; C05F 3/00

(57) ABSTRACT

A method of producing a pelleted substance from a pelleting material having a pathogenic microorganism is disclosed. The method includes heating the pelleting material to a predetermined temperature for a predetermined amount of time effective to induce thermal inactivation of the pathogenic microorganism. A method of producing a pelleted substance from a pelleting material having a keratinous material is disclosed. The method includes heating the pelleting material to a predetermined temperature for a predetermined amount of time effective to induce denaturation or hydrolysis of the keratinous material. A method of operating a system for producing a pelleted substance from a pelleting material including manure material is also disclosed. The method includes thermally controlling a component of the system which directly contacts the pelleting material to heat the pelleting material to a predetermined temperature effective to induce thermal inactivation a pathogenic microorganism.

### CROSS-REFERENCE TO RELATED APPLICATIONS

This application claims priority under 35 U.S.C. § 119(e) to U.S. Provisional Application Ser. No. 62/720,998 titled “System and Method for Thermally Treating Material During Pelleting” filed Aug. 22, 2018, incorporated herein by reference in its entirety for all purposes.

### FIELD OF TECHNOLOGY

Aspects and embodiments disclosed herein relate to systems and methods for thermally treating material during pelleting. In particular, systems and methods involve thermally treating manure or processed manure material during pelleting.

### SUMMARY

In accordance with one aspect, there is provided a method of producing a pelleted substance from a pelleting material comprising at least one pathogenic microorganism. The method may comprise determining at least one property of the pelleting material. The method may comprise selecting a dimension for the pelleted substance. The method may comprise heating the pelleting material to a predetermined temperature and for a predetermined amount of time effective to induce thermal inactivation of the at least one pathogenic microorganism. The method may comprise extruding the pelleting material at the selected dimension to form the pelleted substance.

In some embodiments, the pelleting material may comprise a manure material.

The pelleting material may comprise a poultry manure material.

The predetermined temperature and predetermined amount of time may be effective to pasteurize the pelleting material. The pelleted substance may be substantially free of pathogenic microorganisms.

The predetermined temperature may be between about 55° C. and about 260° C.

The method may comprise forming the pelleted substance having a designation of Class A Biosolid, as defined by the U.S. Environmental Protection Agency.

In some embodiments, the pelleting material may comprise at least one biological material selected from eggs and seeds. The predetermined temperature and predetermined amount of time may be effective to induce thermal inactivation of the at least one biological material.

The pelleting material may comprise at least one keratinous material. The predetermined temperature and the predetermined amount of time may be effective to induce at least one of denaturation and hydrolysis of the at least one keratinous material.

The method may comprise extruding the pelleting material to form the pelleted substance having a substantially homogeneous composition.

The at least one property may comprise a moisture content of the pelleting material.

The predetermined temperature may be between about 40° C. and about 150° C. The predetermined temperature and the predetermined amount of time may be effective to induce starch gelatinization of a starch material present in the pelleting material.

The method may comprise heating the pelleting material to the predetermined temperature for the predetermined amount of time effective to control a physical state of a material selected from elemental sulfur, urea, and wax present in the pelleting material.

The method may comprise heating the pelleting material to the predetermined temperature for the predetermined amount of time effective to control volatilization of a volatile substance present in the pelleting material.

In accordance with another aspect, there is provided a method of producing a pelleted substance from a pelleting material comprising at least one keratinous material. The method may comprise determining at least one property of the pelleting material. The method may comprise selecting a dimension for the pelleted substance. The method may comprise heating the pelleting material to a predetermined temperature and for a predetermined amount of time effective to induce at least one of denaturation and hydrolysis of the at least one keratinous material. The method may comprise extruding the pelleting material at the selected dimension to form the pelleted substance.

In some embodiments, the pelleting material may comprise a manure material.

The pelleting material may comprise a poultry manure material.

The at least one keratinous material may comprise at least one of feathers and hair. The method may comprise extruding the pelleting material to form the pelleted substance having a substantially homogeneous composition.

The predetermined temperature may be between about 20° C. and about 260° C.

The pelleting material may comprise at least one pathogenic microorganism. The predetermined temperature and the predetermined amount of time may be effective to induce thermal inactivation of the at least one pathogenic microorganism.

The predetermined temperature and the predetermined amount of time may be effective to pasteurize the pelleting material. The method may comprise extruding the pelleting material to form the pelleted substance being substantially free of microorganisms.

The method may comprise heating the pelleting material to the predetermined temperature for the predetermined amount of time effective to control a physical state of a material selected from elemental sulfur, urea, and wax present in the pelleting material.

In accordance with yet another aspect, there is provided a method of operating a system for producing a pelleted substance from a pelleting material comprising a manure material. The method may comprise determining a moisture content of the pelleting material. The method may comprise measuring an initial temperature of the pelleting material. The method may comprise thermally controlling at least one component of the system which directly contacts the pelleting material to heat the pelleting material to a predetermined temperature effective to induce thermal inactivation of at least one pathogenic microorganism present in the pelleting material. The method may comprise operating the system to produce the pelleted substance from the pelleting material.

In some embodiments, the pelleting material may comprise at least one volatile substance. The method may comprise thermally controlling the at least one component to heat the pelleting material to a predetermined temperature effective to induce volatilization of the at least one volatile substance.

The at least one volatile substance may comprise at least one of ammonia, uric acid, and urea.

The method may further comprise directing an exhaust gas comprising the volatized at least one volatile substance to a post-treatment or recovery process.

The method may comprise controlling pH of the pelleting material to induce volatilization of the at least one volatile substance.

In some embodiments, controlling pH of the pelleting material may comprise introducing an alkaline substance to the pelleting material in an amount effective to induce volatilization of the at least one volatile substance.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of a portion of a system for producing a pelleted substance, according to one embodiment;

FIG. 2 is an enlarged view of a portion of the schematic diagram of FIG. 1, according to one embodiment;

FIG. 3 is a schematic diagram of a portion of a system for producing a pelleted substance, according to one embodiment;

FIG. 4 is an enlarged view of a portion of the schematic diagram of FIG. 3, according to one embodiment;

FIG. 5 is a box diagram of a system for producing a pelleted substance, according to one embodiment;

FIG. 6 is a box diagram of a system for producing a pelleted substance, according to one embodiment;

FIG. 7 is a box diagram of a system for producing a pelleted substance, according to one embodiment;

FIG. 8 is a box diagram of a system for producing a pelleted substance, according to one embodiment;

FIG. 9 is a graph of temperature of pelleting material for varying percentages of moisture content, according to one embodiment; and

FIG. 10 is a graph of temperature of pelleting material without thermal control, for different operating parameters of a pelleting mill system, according to one embodiment.

### DETAILED DESCRIPTION

Pelleting of a particulate material, also referred to as pelletization, is a process often employed in different industries for densification and agglomeration of particles. Pelleting generally involves compression of a pelleting material into the shape of a pellet. Biological materials may be compressed to produce pellets. For instance, biomass, such as wood and grass, may be compressed to form alternative energy pellets. The biomass pellets may be used as fuel for combustion in a furnace, for example, for generating heat or mechanical or electrical power. Food products may be compressed to form dense aggregates for pet feed. Ores, manures, and other waste materials may be compressed to form dense fertilizer pellets. The fertilizer pellets may provide improved storage and field use. Powdered pharmaceutical compositions may be compressed to form tablets.

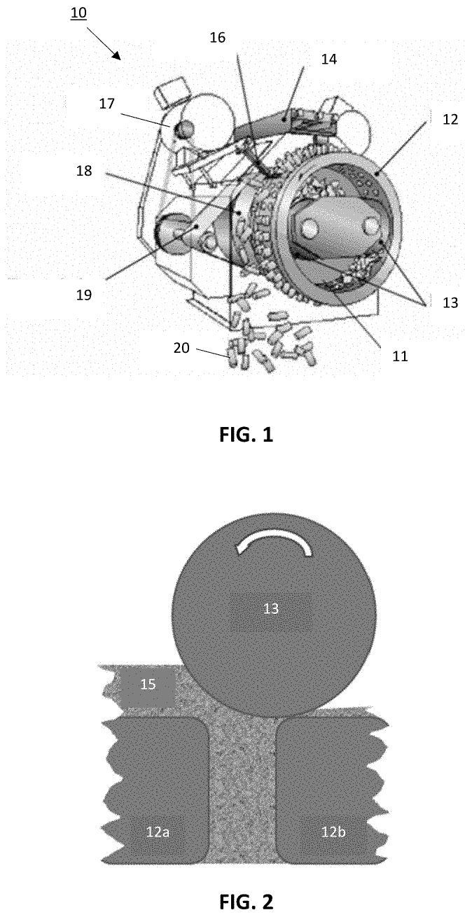

Pelleting may be performed in a pellet mill. As shown in FIG. 1, pellet mill 10 may include a feeder element 14 which introduces the pelleting material into a die chamber 11. A press roll 13 compresses the pelleting material against the die 12. The die 12 may have one or more openings. The press roll 13 may force the pelleting material into the die 12 openings. Through the die 12 openings, the pelleting material may be compressed, densified, aggregated, and extruded. The extruded material may be the pelleted substance 20. Typically, a motor 17 coupled to a shaft 18 by way of a transmission system 19 induces rotational movement necessary for the pelleting mill 10 to perform the pelletization.

FIG. 2 is an enlarged view of a portion of pellet mill 10. As shown in FIG. 2, press roll 13 forces pelleting material against die 12a, 12b. Briefly, the pelleting material may be directed into the die openings (shown between die portions 12a, 12b) as the press roll 13 circulates over the die 12a, 12b. The densified pellet may be extruded out of the die 12a, 12b and broken into pieces by its own weight or by the action of a cutter 16 (shown in FIG. 1) element to form the pellets.

The mechanical energy produced by the motor may dissipate as friction between the particles in the pelleting material and between the material and die. The mechanical energy is often transformed into heat that raises the temperature of the pellet. As the pelleting material is forced by the press rolls into the die holes, porosity reduction may take place as a result of compression. The fluids between the particles, gases, and liquids may evacuate due to the increased pressure. As a result, particles may move and rearrange and come into close contact. Brittle particles may break and malleable particles may deform, thus forming the pellet.

The raw material, or pelleting material, may be forced through the die opening, causing extrusion of the pelleting material and creating high friction between the particles as well as between the pelleting material and the die. High pressures are typically required, in the order of 1000-4000 psi, in the pelletization process to extrude the densified material through the die. As a result of the friction, the temperature of the pelleting material may also increase in an uncontrolled way. The final temperature of the pellet in a conventional manufacturing system may vary significantly and depend on numerous parameters. The parameters to be considered may generally include the geometry of the die, the power of the motor, the chemical composition of the pelleting material, and the physical and rheological characteristics of the pelleting material. Other parameters that have an effect on temperature or composition of the pelleting material may be considered.

Conventional pelleting processes are employed to densify and aggregate the particulate material, forming a durable and homogeneous pellet. Conventional systems do not consider the creation of thermally induced reactions in the pelleting mixture during the pelleting process. As such, variations in temperature during pelleting are not considered critical for the process.

However, for certain manufacturing methods of pelletized material, as in the production of pet feed, manure, or processed manure (for example, composted manure or dried manure), it may be desirable to independently control the temperature of the pelleting material during the pelleting process. Temperature control may enable the production of a consistent final product pelleted substance with predetermined properties, such as inactivation of pathogens and plant seeds, improved agglomeration, or improved digestibility of the ingredients. Thermal inactivation of pathogens and plant seeds may be desirable when the pelleted product is to be used as fertilizer in agricultural crops. For instance, thermal inactivation of pathogens and plant seeds may minimize transference of pathogenic organisms to the crop product and avoid the growth of undesirable plants from the seeds present in the raw pelleting material.

In accordance with one aspect, there is provided a method of producing a pelleted substance from a pelleting material. The method may comprise heating the pelleting material during production of the pellet. In some embodiments, the methods may comprise measuring initial temperature of the pelleting material to determine an amount of thermal energy to be applied to the pelleting material. Any one or more factors may be considered when determining a temperature for heating the pelleting material. For instance, physical properties or composition of the pelleting material may be considered.

The predetermined temperature for heating the pelleting material during production of the pellet may be between about 4° C. and about 260° C., for example, between about 20° C. and about 260° C. The predetermined temperature may be a temperature within a predetermined temperature range. The predetermined temperature range may be between about 55° C. and about 260° C., between about 20° C. and about 240° C., between about 40° C. and about 150° C., between about 70° C. and about 125° C., or between about 90° C. and about 125° C.

In general, the predetermined temperature may be a temperature effective to treat the pelleting material and/or to produce a pelleted substance having a selected property. The methods may comprise heating the pelleting material to a temperature effective to treat an interior portion of the pelleting material, for instance, the core of a pellet. Thus, in some embodiments, a dimension of the pelleted substance may be considered when selecting a predetermined temperature for the pelleting material.

The temperature or dimension may be selected to provide a pelleted substance with a substantially homogeneous composition throughout. A homogeneous composition may be substantially uniform or even throughout the pelleted substance. For instance, a homogeneous pelleted substance may have a substantially uniform composition across different samples, for example, across different pellets. Each pellet may have a substantially uniform composition across different samples of the pellet. A substantially homogeneous composition may be at least 90%, in some embodiments at least 95%, uniform across different samples.

The methods may comprise selecting a dimension for the pelleted substance. The dimension may be, for example, a diameter, length, width, or height of the pelleted substance to be produced. Dimensions such as diameter, length, and height may be controlled by producing the pelleted substance with a pelleting die having an orifice of the selected shape and/or dimension. Dimensions such as width and length may be controlled by selecting velocity of extrusion and/or rate of cutting the pelleted material as it exits the die orifice. Thus, in some embodiments, the methods may comprise extruding the pelleting material at the selected dimension to form the pelleted substance. In certain embodiments, the diameter, length, or height of the pelleted substance may have a dimension of between about 0.125 inch to about 1.5 inch. The diameter, length, or height of the pelleted substance may have a dimension of about 0.125 in, about 0.25 in, about 0.5 in, about 0.6 in, about 0.7 in, about 0.8 in, about 0.9 in, about 1.0 in, about 1.1 in, about 1.2 in, about 1.3 in, about 1.4 in, or about 1.5 in. The predetermined temperature may be selected to be effective in treating the core of the pelleting material having the selected dimension.

The methods may comprise determining at least one property of the pelleting material. The at least one property may comprise composition of the pelleting material. In some embodiments, moisture content of the pelleting material may be considered. For instance, in certain embodiments, the pelleting material may have a moisture content of between about 5% and about 20%. Within the range of 5% to 20%, the thermal energy to be applied to the pelleting material may vary widely. The predetermined temperature to heat the pelleting material may vary widely. In general, a pelleting material having a greater moisture content may require a greater amount of thermal energy and/or a greater predetermined temperature to effect treatment of the pelleting material. A pelleting material having a moisture content of less than 5% may be hydrated to avoid burning when heated. A pelleting material having a moisture content of greater than 20% may be dried prior to processing for production of the pelleted substance. The predetermined temperature may be selected to be effective in treating the pelleting material having the measured moisture content.

In some embodiments, the methods may comprise detecting at least one of pathogen density in the material, protein chemical structure of the material, starch chemical structure of the material, keratinous material malleability, concentration of volatile substances, and physical state of the material. The methods may comprise determining melting point of one or more component of the material. The methods may comprise determining vaporization point of one or more component of the material. The methods may comprise considering melting, mixing, and adhesion of substances present in the pelleting material.

In some embodiments, the pelleting material may be or comprise a biomass or biosolid. The pelleting material may be or comprise a manure material. The pelleting material may comprise, for example, poultry manure or poultry litter. In some embodiments, the poultry manure or poultry litter may comprise chicken manure or chicken litter. Poultry may generally refer to domestic fowl. In some embodiments, poultry may comprise wild game birds. Poultry manure or litter may comprise chicken, turkey, goose, duck, swan, quail, ostrich, or pigeon manure or litter, and combinations thereof. The pelleting material may comprise animal manure or litter, for example, of any domesticated or farm animal. The pelleting material may additionally or alternatively comprise waste sludge or sewage sludge. In some embodiments, the pelleting material may additionally or alternatively comprise food waste, for example, produce waste. Methods disclosed herein may comprise collecting manure, litter, sewage sludge, or food waste. Methods may comprise processing manure, litter, sewage sludge, or food waste to produce a pelleting material.

The pelleting material may comprise one or more pathogenic microorganism. The pathogenic microorganism may be a bacteria, archaea, virus, fungi, or protozoa. Exemplary pathogenic microorganisms include those in the genera Salmonella, Campylobacter, Actinomycetes, Clostridia, Bacilli, Lactobacilli. Other exemplary microorganisms include, for example, Listeria monocytogenes, Yersinia enterocolitica, Escherichia coli, and protozoa viz. Other exemplary microorganisms include, for example, those in the genera Cryptosporidium, Giardia, and Influenza. The pelleting material may comprise a community of pathogenic microorganisms. In certain embodiments, the pelleting material may comprise greater than 1000 CFU/g of pathogenic microorganisms, for example, greater than 1200 CFU/g or greater than 1500 CFU/g.

The pelleting material may comprise one or more organism. The organism may be or comprise helminth eggs. Exemplary organisms include, for example, eggs of tapeworms in the genera Taenia and eggs of roundworms in the genera Ascaris.

The methods may comprise detecting the one or more pathogenic microorganism in the pelleting material. The methods may comprise quantifying the one or more pathogenic microorganism in the pelleting material. Pathogenic microorganisms may be detected and/or quantified, for example, by diagnostic methods including sample cultures, quantitative or qualitative assays, polymerase chain reaction (PCR) and real time polymerase chain reaction (RT-PCR), and other diagnostic methods.

The methods may comprise heating the pelleting material to a predetermined temperature and for a predetermined amount of time effective to induce thermal inactivation of the at least one pathogenic microorganism. “Thermal inactivation” of the pathogenic microorganism may generally refer to heat treatment which inhibits the microorganism's ability to replicate indefinitely under suitable conditions. The predetermined temperature and amount of time may be effective to induce thermal inactivation of at least 90% of the culture of the pathogenic microorganism. In some embodiments, the predetermined temperature and amount of time may be effective to induce thermal inactivation of at least 92%, at least 95%, at least 97%, at least 99%, at least 99.5%, at least 99.99%, or at least 99.99% of the pathogenic microorganism. The predetermined temperature may be greater than about 70° C. The predetermined temperature may be a temperature at which the center of the pellet will be 70° C. after less than 1 minute, or from about 1 to about 2 minutes, of heat treatment.

The predetermined temperature and predetermined amount of time may be effective to pasteurize the pelleting material. Pasteurization of the pelleting material may generally refer to heat treatment which is effective to destroy or deactivate all pathogenic microorganisms. The predetermined temperature and amount of time may be effective to deactivate or destroy at least 90% of the pathogenic microorganism population. In some embodiments, the predetermined temperature and amount of time may be effective to deactivate or destroy at least 92%, at least 95%, at least 97%, at least 99%, at least 99.5%, at least 99.99%, or at least 99.99% of the pathogenic microorganism population. The predetermined temperature may be greater than about 90° C. The predetermined temperature may be a temperature at which the center of the pellet will be 90° C. after less than about 1 minute, or from about 1 to about 2 minutes, of heat treatment.

The predetermined temperature and predetermined amount of time may be effective to sterilize the pelleting material. Sterilization of the pelleting material may generally refer to heat treatment which is effective to destroy or deactivate microorganisms or organisms and their spores or eggs. Thus, the pelleted substance may be substantially free of pathogenic microorganisms. The pelleted substance may be substantially free of organisms. For instance, the pelleted substance may be at least 99%, at least 99.9%, at least 99.99%, or at least 99.999% free of microorganisms or organisms. The predetermined temperature may be greater than about 100° C. The predetermined temperature may be a temperature at which the center of the pellet will be 100° C. after less than about 1 minute or from about 1 to about 2 minutes of heat treatment.

The temperature applied to the pelleting material during production of the pellet to thermally inactivate, pasteurize, or sterilize a pathogenic microorganism or organism population may be between about 55° C. and about 260° C.

In certain embodiments, the method may comprise comprising forming the pelleted substance having a designation of Class A Biosolid, as defined by the U.S. Environmental Protection Agency (EPA). Thus, for a determined pelleting material being formed into a pelleted substance having a selected dimension, the temperature and amount of time for heat treatment may be effective to form a pelleted substance having a designation of Class A Biosolid. In general, a class A Biosolid meets the EPA guidelines for land application with no restrictions, such that it can be used as a fertilizer product. A Class A Biosolid may be free of pathogenic microorganisms below detectable levels. Detectable levels of pathogenic microorganisms include 3 MPN/4 g TS of Salmonella and 1000 MPN/g TS of fecal coliform.

Class A Biosolid designation may be provided to biosolids treated by a variety of methods, as directed by the U.S. EPA. The regulated predetermined time and temperature for heat treatment of a biosolid having more than 7% solids is shown in equation:

$$D = \frac{131 , 700 , 000}{{10}^{0.14 t}}$$

where D is time in days and t is temperature in degrees Celsius.

The pelleting material may contain organic material, such as soil. The pelleting material may contain biological material. For instance, the pelleting material may additionally or alternatively comprise one or more of eggs and seeds. In particular, seeds of undesirable plants or weeds may contaminate a pelleted substance intended to be used as fertilizer. The predetermined temperature and predetermined amount of time may be effective to induce thermal inactivation of the at least one biological material. In some embodiments, the predetermined temperature and amount of time to thermally inactivate a biological material may be between about 55° C. and about 260° C. for less than 1 minute or from about 1 to about 2 minutes.

The pelleting material may comprise proteins, such as, keratinous proteins. The keratinous proteins may comprise feathers or hair. Other exemplary keratinous proteins include finger nails, toe nails, hooves, claws, and horns. Keratinous substances may soften and become more malleable with applied heat, altering the rheological characteristics of the pelleted substance. Heating the pelleting material may induce softening and enhance flow of the pelleting material through the die, aiding in agglomeration of the particles to form the pellet. In accordance with certain embodiments, the predetermined temperature and the predetermined amount of time may be effective to soften the keratinous material to provide a pelleted substance with a desired rheological property. The predetermined temperature may be below about 90° C., for example, between about 40° C. and about 90° C. for less than 1 minute or from about 1 to about 2 minutes.

In accordance with other embodiments, the predetermined temperature and the predetermined amount of time may be effective to induce at least one of denaturation and hydrolysis of the keratinous protein. Denaturation and/or hydrolysis of the keratinous material during production of the pelleted substance may provide a pelleted substance having a substantially homogeneous composition. The substantially homogeneous composition may be at least 90%, in some embodiments at least 95%, uniform across different samples. The predetermined temperature may be above about 90° C., for example, between about 90° C. and about 260° C. for less than about 1 minute or from about 1 to about 2 minutes.

Yet in other embodiments, the predetermined temperature and the predetermined amount of time may be effective to prevent or inhibit denaturation or hydrolysis. In certain embodiments, the avoidance of denaturation or hydrolysis may be desirable. Heat may be transferred away from the pelleting material to avoid denaturation of sensitive proteins. The pelleting material may be cooled to a temperature below about 40° C., for example, between about 20° C. and about 40° C.

The pelleting material may comprise starches that are subject to gelatinization upon exposure to certain temperatures. Gelatinization may improve agglomeration of the particles, improving the characteristics of the pellet. Thus, in some embodiments, the predetermined temperature and the predetermined amount of time may be effective to induce starch gelatinization of a starch material present in the pelleting material. The predetermined temperature may be between about 40° C. and about 150° C. for less than about 1 minute or from about 1 to about 2 minutes.

The pelleting material may comprise substances that are subject physical state change. For instance, the pelleting material may comprise substances that are subject to melting or softening upon application of thermal energy. Exemplary substances that may be melted or softened include waxes, urea materials, and elemental sulfur materials. Melting or softening of the one or more components of the pelleting material may increase fluidity of the material, thus facilitating extrusion and enhancing agglomeration of the particles to form the pellet. The method may comprise heating the pelleting material to the predetermined temperature for the predetermined amount of time effective to control a physical state of at least one component of the pelleting material. In particular, the predetermined temperature and predetermined amount of time may be effective to induce melting of at least one component of the pelleting material. The predetermined temperature and predetermined amount of time may be effective to induce softening to a selected consistency of at least one component of the pelleting material. The predetermined temperature for heating the pelleting material during production of the pellet may be between about 20° C. and about 240° C.

In other embodiments, avoidance of physical state changes, such as melting, of at least one component of the pelleting material may be desirable. In such embodiments, heat may be transferred away from the pelleting material to avoid a physical state change. The predetermined temperature and the predetermined amount of time may be effective to prevent or inhibit physical state changes, such as melting, of at least one component of the pelleting material. Where the at least one component is found in a liquid state (for example, due to heat transferred from the motor or use of mechanical components), the method may comprise cooling the pelleting material to solidify the at least one liquid component.

The pelleting material may comprise substances that are subject to volatilization. Certain pelleting materials may comprise compounds that become volatile or, being volatile, volatilize easier with increased temperature. Exemplary volatile compounds include ammonia, uric acid, and urea. Other exemplary volatile compounds include volatile organic compounds (VOCs). In particular, methane is an exemplary VOC. Another exemplary VOC is terpene. The methods may comprise heating the pelleting material to a predetermined temperature for a predetermined amount of time effective to induce volatilization of the at least one volatile substance. The exhaust gas comprising volatilized compound may be collected, treated, directed to a point of use, and/or discarded. In some embodiments, makeup gas, for example, a sweep gas, may be added to facilitate collection of the exhaust gas. Makeup gas or sweep gas may be added to convey the volatilized substances to the gas processing unit for treatment and/or recovery. The makeup gas or sweep gas may generally be an inert gas.

The volatilized substance may be collected for further use. Thus, un some embodiments, the exhaust gas may be treated for separation of the volatilized substance. Pursuant to such methods, two gas streams may be created. A first stream may comprise the volatilized substance as a recovered substance. The first stream may comprise at least 70%, at least 75%, at least 80%, at least 85%, at least 90%, at least 95%, at least 99%, or at least 100% of the volatilized substance. A second stream may comprise treated gas. In some embodiments, the treated gas may comprise the remainder of the volatilized substance. In certain embodiments, the treated gas may be substantially free of the volatilized or recovered substance. The first stream may be collected or directed to a point of use. The second stream may meet regulatory discharge requirements. Thus, in some embodiments, the second stream may be discarded.

In other embodiments, avoidance of volatilization of at least one volatile compound present in the pelleting material may be desirable. In such embodiments, heat may be transferred away from the pelleting material to avoid volatilization. The predetermined temperature and the predetermined amount of time may be effective to prevent or inhibit volatilization of the volatile compound present in the pelleting material.

The methods may comprise controlling pH of the pelleting material. The pH may be controlled by the addition of an alkaline material or an acidic material. In particular, it is known that different crops benefit from different soil pH ranges. Soil pH varies by geographic region. Factors such as rainfall and climate may affect soil pH. Many crops grow effectively in a soil pH of between 6.0 and 7.0. However, soil pH is often more acidic. The pelleting material may be controlled to have a pH effective to give the soil a pH between 6.0 and 7.0. In other embodiments, the pelleting material may be controlled to have a pH effective to give the soil a pH between 5.0 and 5.5, between 5.5 and 6.5, or between 6.5 and 7.5. Certain crops, for example, blueberries and potatoes, benefit from a soil pH of between 5.0 and 5.5. Other crops, for example, barley, corn, cotton, rice, and soybeans, benefit from a soil pH of between 5.5 and 6.5. Yet other crops, for example, alfalfa, clovers, and sugar beets, benefit from a soil pH of between 6.5 and 7.0.

In certain embodiments, pH may be controlled to induce or prevent volatilization of the at least one volatile substance. In such embodiments, controlling pH of the pelleting material may comprise introducing an acid or alkaline substance to the pelleting material in an amount effective to induce or prevent volatilization of the at least one volatile substance. Exemplary alkaline materials include calcium oxide, ammonia, ammonium hydroxide, calcium hydroxide, potassium, potassium hydroxide, potassium carbonate, sodium, sodium carbonate, sodium hydroxide, sodium peroxide, sodium silicate, and trisodium phosphate. Exemplary acidic materials include ammonium sulfate, potassium chloride, and sulfur.

In particular, a pH above 8.0 may induce volatilization of ammonia. Thus, an alkaline substance may be added to control pH of the pelleting material to be above 8.0 and induce volatilization of ammonia. Additionally, urea hydrolysis to ammonia may be controlled by increasing pH of the pelleting material. In some embodiments, an alkaline substance may be added to control pH of the pelleting material to be above 8.2, increase urea hydrolysis to ammonia and inducing volatilization of the ammonia. Additionally or alternatively, urease may be added to further increase urea hydrolysis. Similarly, to reduce urea hydrolysis and limit ammonia volatilization, pH may be controlled to be less than 8.2 or less than 8.0.

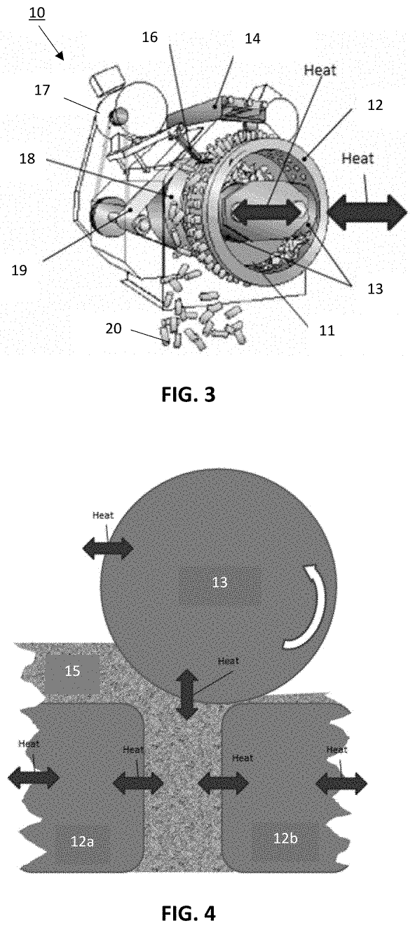

The systems and methods disclosed herein may be employed for simultaneously thermally controlling and densifying the pelleting material during the pellet production process. The pelleting material may be thermally controlled by adding or removing heat. FIGS. 3 and 4 illustrate one method of thermally controlling the pelleting material, which includes thermally controlling at least one component of a system for producing the pelleted substance. Briefly, FIG. 4 is a schematic diagram of the pellet mill 10 shown in FIG. 1, additionally showing heat transfer between a component of the pellet mill 10 (here, press roll 13 and press die 12) and the pelleting material. FIG. 4 is an enlarged view of the portion of pellet mill 10 as shown in FIG. 2, and further showing heat transfer between the press roll 13 and press die 12. Thus, in accordance with certain embodiments, temperature control of the pelleting material during pellet production may be provided by thermal exchange with a component of pellet mill 10 which directly contacts the pelleting material. Any component of pellet mill 10 which directly contacts pelleting material may be thermally controlled to apply or remove heat from the pelleting material. The temperature control of each component of the system may be set independently to provide flexibility in operation. In certain embodiments, the pelleting material may be thermally controlled upstream from the pellet mill 10. In certain embodiments, the pellet mill 10 may be placed or operated within a temperature controlled unit.

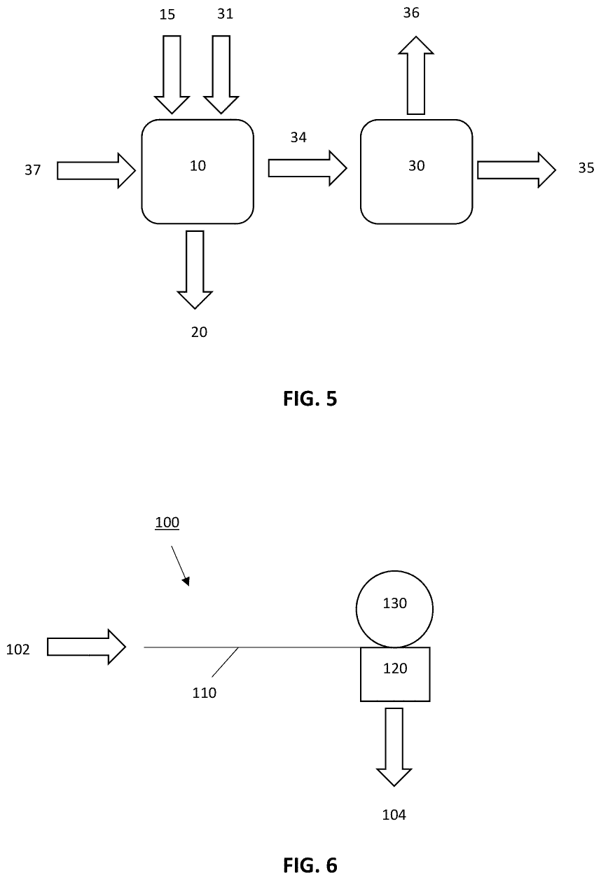

In some embodiments, the pellet mill may also include a chamber for collecting the gases in the die chamber and conveying those gases to a separate gas processing equipment for treatment and/or for substance recovery. FIG. 5 is a box diagram of a system for recovery of volatilized substances. As shown in FIG. 5, pelleting material 15 may be introduced into pellet mill 10. Pellet mill 10 may be temperature controlled. Alkaline substance 31 may be introduced into pellet mill 10 to control pH of the pelleting material 15. Make up gas 37 may be introduced into pellet mill 10 to direct extracted gas 34 to a gas processing subsystem 30. Pellets 20 may be produced by pellet mill 10. In the gas processing subsystem 30, extracted gas 34 may be separated into a first stream 35 comprising the recovered substance and a second stream 36 comprising treated gas. The second stream 36 may be discarded.

In accordance with one aspect, there is provided a method of operating a system for producing a pelleted substance. The method may comprise thermally controlling at least one component of the system which directly contacts the pelleting material to control temperature of the pelleting material. In some embodiments, the component of the system may be thermally controlled to heat the pelleting material to a predetermined temperature, as previously described. In other embodiments, the component of the system may be thermally controlled to absorb heat from the pelleting material, as previously described. The method may generally comprise operating the system to produce the pelleted substance from the pelleting material.

In certain embodiments, the method may comprise determining at least one property of the pelleting material. For example, the method may comprise determining composition of the pelleting material. Composition may be determined by testing a sample of the pelleting material. In other embodiments, composition may be determined by in-line equipment positioned upstream from a pelleting mill. The method may comprise measuring an initial temperature of the pelleting material. Temperature may be measured by a temperature sensor positioned within or upstream of a pelleting mill. In certain embodiments, as previously described, the method may comprise directing an exhaust gas comprising a volatized substance to a post-treatment or recovery system.

The pelleted substance may be produced with a system configured to process the pelleted material. FIG. 6 is a box diagram of an exemplary system for producing a pelleted substance. System 100 includes inlet 102 for receiving the pelleting material, outlet 104 for dispensing the pelleted substance, and channel 110 extending between inlet 102 and outlet 104. Within channel 110, system 100 includes a pelleting die 120 and a pelleting press roll 130. The pelleting die 120 may have an opening or comprise an array of openings. the pelleting press roll 130 is constructed and arranged to extrude the pelleting material through the opening of the pelleting die 120. At least one or both of the pelleting die 120 and the pelleting press roll 130 may be thermally controlled to heat or cool the pelleting material as it is extruded. In general, at least one or both of the pelleting die 120 and pelleting press roll 130 may be formed or comprise a material effective to thermally control temperature of the pelleting material. Thus, the material may have good heat conductance.

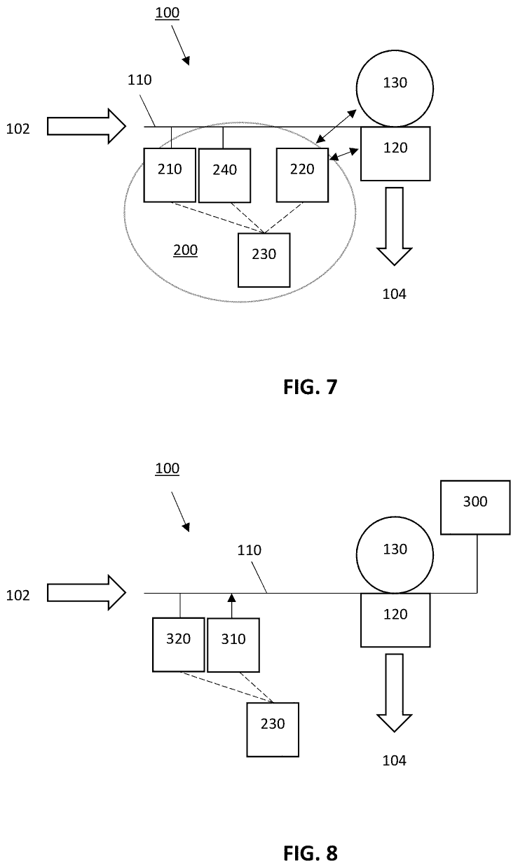

As shown in FIG. 7, system 100 may contain or be associated with a temperature control subsystem 200. The temperature control subsystem 200 may include at least one temperature sensor 210. The temperature sensor 210 as shown in FIG. 7 is configured to measure temperature of the pelleting material. However, the subsystem 200 may additionally or alternatively include a temperature sensor configured to measure temperature of the pelleted substance, of one or more component of the system 100, and of an exhaust gas.

Temperature control subsystem 200 may comprise an energy source 220. The energy source 220 may be configured to transfer energy between the temperature control subsystem 200 and the one or more component of the system 100 which contacts the pelleting material, such as the pelleting die 120 and the pelleting press roll 130. The energy source 220 may be configured to transmit electrical or thermal energy. For instance, the energy source 220 may be configured to transmit electrical energy to a heater associated with the one or more component of the system 100. In other embodiments, the energy source 220 may be configured to transmit thermal energy to the one or more component of the system 100 by a coolant or heating fluid. Thus, the energy source 220 may be electrically connected to the one or more component of the system 100 or fluidly connected to the one or more component of the system 100.

The temperature control subsystem 200 may comprise a controller 230. The controller 230 may be operatively connected to the energy source 220 and the temperature sensor 210. In use, the controller 230 may be configured to instruct the energy source 220 to transfer energy responsive to the measurement obtained by the temperature sensor 210. The controller 230 may be configured to instruct the energy source 220 to transfer energy effective to control the temperature of the pelleting material to a range of between about 4° C. and about 260° C., for example between about 20° C. and about 260° C.

The system 100 may comprise a composition sensor 240 configured to measure a property of the pelleting material. Additionally or alternatively, the system may comprise a composition sensor configured to measure a property of the pelleted substance or an exhaust gas. The controller 230 may be operatively connected to the composition sensor 240. The controller 230 may be configured to instruct the energy source 220 to transfer energy responsive to the property of the pelleting material measured by the composition sensor 240. The property may include, for example, at least one of composition, water content, and density. In general, the property may include any measurable property that may have an effect on specific heat capacity of the pelleting material.

As shown in FIG. 8, the system 100 may contain or be associated with an exhaust control subsystem 300 fluidly connected to the channel 110. The exhaust control subsystem 300 may be configured to capture at least one volatized substance from the pelleting material. The exhaust control subsystem 300 may comprise a recycle or redirect channel. The exhaust control subsystem 300 may comprise an exhaust treatment unit, for example, a gas scrubber or gas filter. The exhaust control subsystem 300 may be configured to collect or treat exhaust gas for further use or for compliant discharge.

The system may comprise a source of an alkaline substance 310 fluidly connectable to the pelleting material. The source of the alkaline substance 310 may be configured to introduce an alkaline substance to the pelleting material in an amount effective to induce volatilization of at least one volatile substance of the pelleting material. The source of the alkaline substance 310 may comprise one or more alkaline substance selected from calcium oxide, ammonia, ammonium hydroxide, calcium hydroxide, potassium, potassium hydroxide, potassium carbonate, sodium, sodium carbonate, sodium hydroxide, sodium peroxide, sodium silicate, and trisodium phosphate. The alkaline substance may be in liquid, solid, semi-solid, or gas form. The alkaline substance may be in suspension or a slurry. Similarly, the system may comprise a source of an acid substance (not shown, but similar to 310) fluidly connectable to the pelleting material.

The system may comprise a pH meter 320. The pH meter 320 may be configured to measure pH of the pelleting material. Additionally or alternatively, the pH meter 320 may be configured to measure pH of the exhaust gas or the pelleted substance.

The controller 230 may be operatively connected to the source of the alkaline substance 310 and the pH meter 320. The controller 230 may be configured to instruct the source of the alkaline substance 310 to administer the alkaline substance responsive to the measurement obtained by the pH meter 320. In general, the controller 230 may be configured to instruct the source of the alkaline substance 310 to administer the alkaline substance in an amount effective to control pH of the pelleting material. For instance, the controller 230 may be configured to instruct the source of the alkaline substance 310 to administer the alkaline substance in an amount effective to induce volatilization of at least one volatile substance of the pelleting material.

The system may comprise one or more pumps, valves, and meters. In some embodiments, the controller 230 may actuate instructions via operative connections with the pumps, valves, and meters. The controller 230 may comprise a memory storing device for storing data related to the pelleting material properties and system operating parameters. The controller 230 may comprise a processor for operating the various system components. The controller 230 may be operatively connected to one or more input device for programming operation.

### EXAMPLES

The function and advantages of these and other embodiments will be more fully understood from the following non-limiting examples. The examples are intended to be illustrative in nature and is not to be considered to be limiting to the scope of the embodiments discussed herein.

### Example 1: Effect of Varying Moisture Content of the Pelleting Material on Temperature of the Pellet

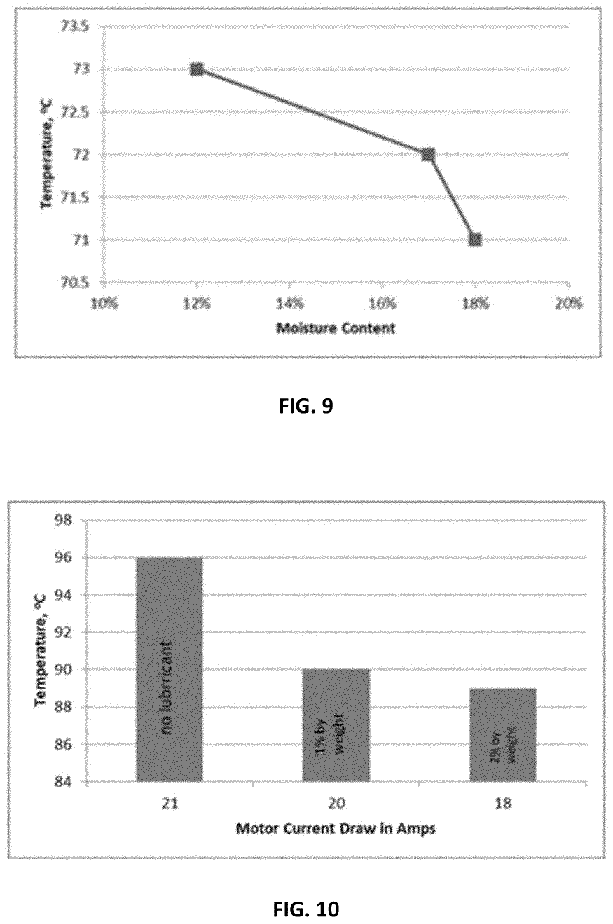

A ground wood mixture of pine and poplar wood was pelleted for production of wood pellets. Moisture content of the pelleting material was varied between 12% and 18%. Temperature of the produced pellet without temperature control was measured. As shown in the graph of FIG. 9, without temperature control, the temperature of pellets produced with a greater moisture content was lower than the temperature of pellets produced with a lower moisture content. Briefly, pelleting material having 12% moisture produced pellets having a temperature of 73° C., pelleting material having 17% moisture produced pellets having a temperature of 72° C., and pelleting material having 18% moisture produced pellets having a temperature of 71° C.

Thus, increased moisture content in the pelleting material has an inverse effect on absorption of heat. Accordingly, pelleting material with a greater moisture content may require more thermal energy to be heated to a selected predetermined temperature.

### Example 2: Effect of Densification and Aggregation of Pelleting Material Particles on Temperature of the Pellet

The pine and poplar wood pellets of example 1 were treated with additives to enhance densification and aggregation of the pellet material. Lubricant was added to the pelleting material in concentrations of 1 wt % and 2 wt %. As shown in the graph of FIG. 10, the addition of the additives significantly reduces the amount of energy required to produce the pellet substance. Additionally, without temperature control, the addition of additives significantly reduces temperature of the produced pellet substance. Briefly, the pelleting material having 1 wt % lubricant required 20 amps for production of the pellet and produced a pellet having a temperature of 90° C., and the pelleting material having 2 wt % lubricant required 18 amps for production of the pellet and produced a pellet having a temperature of 89° C. Comparatively, the pelleting material having no lubricant required 21 amps for production of the pellet and produced a pellet having a temperature of 96° C.

Thus, temperature may be controlled by the addition of a densifying and aggregating lubricant. Additionally, pelleting material having such densifying and aggregating lubricant may require more thermal energy to be heated to a selected predetermined temperature.

### Example 3: Pelletization of Raw Chicken Manure

Raw chicken manure pelleting material was pelletized according to the embodiments disclosed herein. Temperature of the pelleting die was controlled to 240° F. (115.56° C.). The temperature control of the pelleting material was performed during extrusion. Contact of the pelleting material with the temperature controlled die lasted between about less than 1 minute to about 2 minutes. The diameter of the die orifice (and thus, the diameter of the pelleted material) was 1 inch.

Moisture content of the pelleted substance was between about 5% to about 7% less than the moisture content of the raw chicken manure. The composition of two samples the pelleted substance is shown in Tables 1A-1B.

TABLE 1A
Composition of Sample 1 of the Pelleted Substance

| | Measured | Dry Weight | Units | Limit |
|---|---|---|---|---|
| Nitrogen (total) | 4.07 | 4.55 | % | 0.01 |
| Phosphate (P2O5) | 4.40 | 4.92 | % | 0.10 |
| Potash (K2O) | 2.68 | 3.00 | % | 0.05 |
| Salmonella | <0.01 | <0.01 | MPN/4g | 0.01 |
| Fecal Coliforms | <0.2 | <0.2 | MPN/g | 0.2 |
| Lead (total) | <5.0 | <5.0 | mg/kg | 5.0 |
| Cadmium (total) | <0.50 | <0.50 | mg/kg | 0.50 |
| Arsenic (total) | <10.0 | <10.0 | mg/kg | 10.0 |
| pH | 7.91 | | S.U. | 0.01 |
| Moisture | 10.60 | | % | 0.10 |

TABLE 1B
Composition of Sample 2 of the Pelleted Substance

| | Measured | Dry Weight | Units | Limit |
|---|---|---|---|---|
| Nitrogen (total) | 4.66 | 5.28 | % | 0.01 |
| Phosphate (P2O5) | 4.56 | 5.15 | % | 0.10 |
| Potash (K2O) | 2.98 | 3.38 | % | 0.05 |
| Salmonella | <0.01 | <0.01 | MPN/4g | 0.01 |
| Fecal Coliforms | <0.2 | <0.2 | MPN/g | 0.2 |
| Lead (total) | <5.0 | <5.0 | mg/kg | 5.0 |
| Cadmium (total) | <0.50 | <0.50 | mg/kg | 0.50 |
| Arsenic (total) | <10.0 | <10.0 | mg/kg | 10.0 |
| pH | 7.70 | | S.U. | 0.01 |
| Moisture | 11.71 | | % | 0.10 |

The pelleting material was pasteurized during extrusion. Fecal coliforms and salmonella were below detection limits. The pelleted substance meets the requirements for Class A Biosolid, as defined by the EPA.

Thus, pathogenic microorganisms in raw chicken manure may be thermally inactivated by the methods described herein. Furthermore, raw chicken manure pelleting material may be extruded into a Class A (EPA) fertilizer product by the methods described herein.

It is to be appreciated that various alterations, modifications, and improvements will readily occur to those skilled in the art. Such alterations, modifications, and improvements are intended to be part of this disclosure, and are intended to be within the spirit and scope of the disclosure. In other instances, an existing facility may be modified to utilize or incorporate any one or more aspects of the methods and systems described herein. Accordingly the foregoing description and figures are by way of example only. Further the depictions in the figures do not limit the disclosures to the particularly illustrated representations.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of’ and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While exemplary embodiments have been disclosed, many modifications, additions, and deletions may be made therein without departing from the spirit and scope of the disclosure and its equivalents, as set forth in the following claims.

What is claimed is:

1. A method of producing a pelleted substance from a pelleting material comprising at least one pathogenic microorganism, the method comprising:
determining at least one property of the pelleting material;
selecting a dimension for the pelleted substance;
heating the pelleting material to a predetermined temperature and for a predetermined amount of time effective to induce thermal inactivation of the at least one pathogenic microorganism; and
extruding the pelleting material at the selected dimension to form the pelleted substance.

2. The method of claim 1, wherein the pelleting material comprises a manure material.

3. The method of claim 2, wherein the pelleting material comprises a poultry manure material.

4. The method of claim 3, wherein the predetermined temperature and predetermined amount of time are effective to pasteurize the pelleting material, and the pelleted substance is substantially free of pathogenic microorganisms.

5. The method of claim 1, wherein the predetermined temperature is between about 55° C. and about 260° C.

6. The method of claim 5, comprising forming the pelleted substance having a designation of Class A Biosolid, as defined by the U.S. Environmental Protection Agency.

7. The method of claim 1, wherein the pelleting material comprises at least one biological material selected from eggs and seeds, and the predetermined temperature and predetermined amount of time are effective to induce thermal inactivation of the at least one biological material.

8. The method of claim 1, wherein the pelleting material comprises at least one keratinous material, and the predetermined temperature and the predetermined amount of time are effective to induce at least one of denaturation and hydrolysis of the at least one keratinous material.

9. The method of claim 8, comprising extruding the pelleting material to form the pelleted substance having a substantially homogeneous composition.

10. The method of claim 1, wherein the at least one property comprises a moisture content of the pelleting material.

11. The method of claim 1, wherein the predetermined temperature is between about 40° C. and about 150° C., and the predetermined temperature and the predetermined amount of time are effective to induce starch gelatinization of a starch material present in the pelleting material.

12. The method of claim 1, comprising heating the pelleting material to the predetermined temperature for the predetermined amount of time effective to control a physical state of a material selected from elemental sulfur, urea, and wax present in the pelleting material.

13. The method of claim 1, comprising heating the pelleting material to the predetermined temperature for the predetermined amount of time effective to control volatilization of a volatile substance present in the pelleting material.

14. A method of producing a pelleted substance from a pelleting material comprising at least one keratinous material, the method comprising:
determining at least one property of the pelleting material;
selecting a dimension for the pelleted substance;
heating the pelleting material to a predetermined temperature and for a predetermined amount of time effective to induce at least one of denaturation and hydrolysis of the at least one keratinous material; and
extruding the pelleting material at the selected dimension to form the pelleted substance.

15. The method of claim 14, wherein the pelleting material comprises a manure material.

16. The method of claim 15, wherein the pelleting material comprises a poultry manure material.

17. The method of claim 14, wherein the at least one keratinous material comprises at least one of feathers and hair, and the pelleted substance has a substantially homogeneous composition.

19. The method of claim 14, wherein the predetermined temperature is between about 20° C. and about 260° C.

20. The method of claim 19, wherein the pelleting material comprises at least one pathogenic microorganism, and the predetermined temperature and the predetermined amount of time are effective to induce thermal inactivation of the at least one pathogenic microorganism.

21. The method of claim 20, wherein the predetermined temperature and predetermined amount of time are effective to pasteurize the pelleting material, and the pelleted substance is substantially free of pathogenic microorganisms.

22. The method of claim 14, comprising heating the pelleting material to the predetermined temperature for the predetermined amount of time effective to control a physical state of a material selected from elemental sulfur, urea, and wax present in the pelleting material.

23. A method of operating a system for producing a pelleted substance from a pelleting material comprising a manure material, the method comprising:
determining a moisture content of the pelleting material;
measuring an initial temperature of the pelleting material;
thermally controlling at least one component of the system which directly contacts the pelleting material to heat the pelleting material to a predetermined temperature effective to induce thermal inactivation of at least one pathogenic microorganism present in the pelleting material; and
operating the system to produce the pelleted substance from the pelleting material.

24. The method of claim 23, wherein the pelleting material comprises at least one volatile substance, the method comprising thermally controlling the at least one component to heat the pelleting material to a predetermined temperature effective to induce volatilization of the at least one volatile substance.

25. The method of claim 24, wherein the at least volatile substance comprises at least one of ammonia, uric acid, and urea.

26. The method of claim 24, further comprising directing an exhaust gas comprising the volatized at least one volatile substance to a post-treatment or recovery process.

27. The method of claim 24, further comprising controlling pH of the pelleting material to induce volatilization of the at least one volatile substance.

28. The method of claim 27, wherein controlling pH of the pelleting material comprises introducing an alkaline substance to the pelleting material in an amount effective to induce volatilization of the at least one volatile substance.
